(19) United States
(12) Patent Application Publication
(10) Pub. No.: US 2025/0042299 A1
(43) Pub. Date: Feb. 6, 2025

(54) ABNORMALITY DETECTION SYSTEM, ABNORMALITY DETECTION METHOD, AND NON-TRANSITORY COMPUTER-READABLE RECORDING MEDIUM

(71) Applicant: Panasonic Intellectual Property Management Co., Ltd., Osaka (JP)

(72) Inventors: Takashi MATSUDA, Osaka (JP); Shinya NISHIKAWA, Osaka (JP)

(21) Appl. No.: 18/719,706

(22) PCT Filed: Nov. 29, 2022
(86) PCT No.: PCT/JP2022/043867

§ 371 Date: Jun. 13, 2024

(30) Foreign Application Priority Data
Dec. 21, 2021 (JP) 2021-206950

(51) Int. Cl. B60L 58/24; G01K 1/02; G01K 3/00; H01M 10/48; H01M 50/249

(52) U.S. Cl. CPC B60L 58/24; G01K 1/026; G01K 3/005; H01M 10/482; H01M 10/486; H01M 50/249; H01M 2220/20

(57) ABSTRACT

A data acquisition unit acquires temperature data for a plurality of battery packs mounted on different equipment (e.g., electric-powered vehicle) in a predetermined period. A statistical calculation unit calculates, for each battery pack, a statistical value based on a temperature change rate in a plurality of charging periods included in the predetermined period. A determination unit determines a temperature adjustment function of the equipment for which a deviation of the statistical value based on the temperature change rate is equal to or greater than a threshold value to be abnormal.

### CROSS-REFERENCE TO RELATED APPLICATIONS

This application is based upon and claims the benefit of priority from the prior Japanese Patent Application No. 2021-206950, filed on Dec. 21, 2021, and the International Patent Application No. PCT/JP2022/043867, filed on Nov. 29, 2022, the entire content of each of which is incorporated herein by reference.

### BACKGROUND

### Field of the Invention

The present disclosure relates to an abnormality detection system, an abnormality detection method, and an abnormality detection program for detecting an abnormality of the temperature adjustment function of a battery pack.

### Description of the Related Art

In recent years, electric-powered vehicles (EVs, HEVs, and PHEVs) are generally equipped with a temperature adjustment mechanism for the purpose of extending the life of the battery pack, etc. For example, the vehicle is equipped with a heater for heating the cells in the battery pack and a cooler for cooling the cells. It is necessary to diagnose whether these temperature adjustment mechanisms are functioning normally.

A method has been proposed in which a temperature sensor is provided at each of the inlet part and the outlet part of the battery part, and an abnormality of the temperature adjustment system is detected by comparing a difference between detection values and the first threshold value (see, for example, Patent Literature 1). This method requires providing a temperature sensor at the inlet part and the outlet part, which increases the cost.

A method of detecting an abnormality of the cooling system when the temperature of the battery is higher than a predetermined temperature, based on the temperature in the vehicle interior and the temperature of the air cooling the battery has also been proposed (see, for example, Patent Literature 2). In this method, it is necessary to acquire the environmental temperature in the vehicle interior.

A method of diagnosing the temperature adjustment mechanism only from the temperature data for the cells without using the environmental temperature is also conceivable. However, it is difficult to determine whether a change in the temperature data is due to a change in the environmental temperature or a failure of the temperature adjustment mechanism.
Patent Literature 1: JP2019-21387
Patent Literature 2: JP2004-291721

### SUMMARY OF THE INVENTION

The present disclosure addresses the issue described above, and a purpose thereof is to provide a technology capable of diagnosing the temperature adjustment function of a battery at low cost while also suppressing the influence of environmental temperature.

An abnormality detection system according to an embodiment of the present disclosure includes: a data acquisition unit that acquires temperature data for a plurality of battery packs mounted on different equipment in a predetermined period; a statistical calculation unit that calculates, for each battery pack, a statistical value based on a temperature change rate in a plurality of charging periods included in the predetermined period; and a determination unit that determines a temperature adjustment function of the equipment for which a deviation of the statistical value based on the temperature change rate is equal to or greater than a threshold value to be abnormal.

Optional combinations of the aforementioned constituting elements, and implementations of the present disclosure in the form of apparatuses, systems, methods, and computer programs are also useful as embodiments of the present disclosure.

Embodiments will now be described, by way of example only, with reference to the accompanying drawings which are meant to be exemplary, not limiting, and wherein like elements are numbered alike in several Figures, in which:

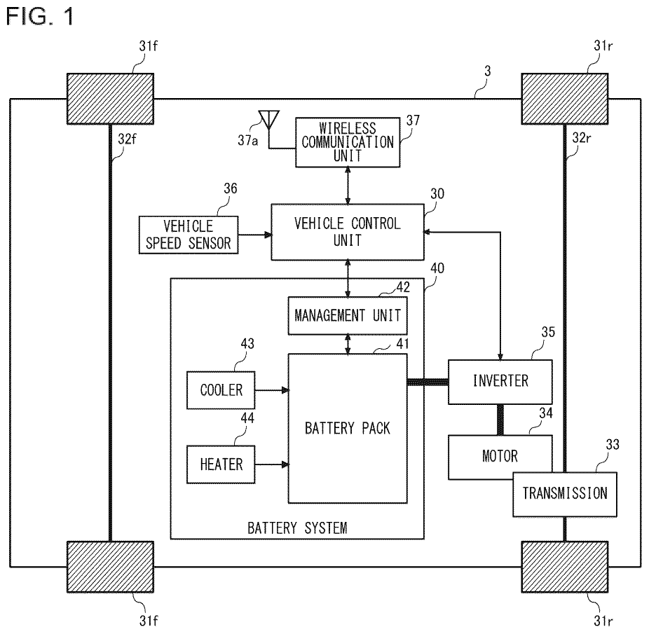

FIG. 1 is a diagram showing a schematic configuration of an electric-powered vehicle according to the embodiment.

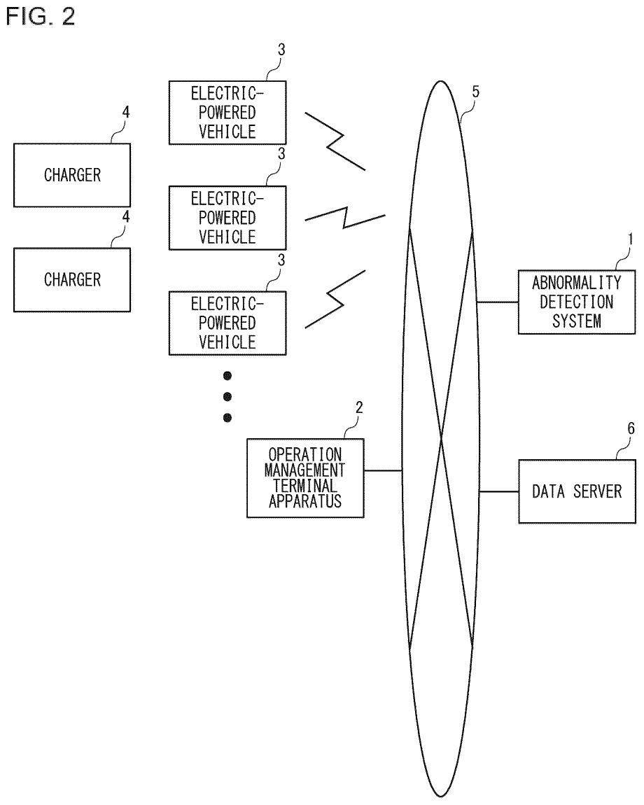

FIG. 2 is a diagram for illustrating an abnormality detection system according to the embodiment.

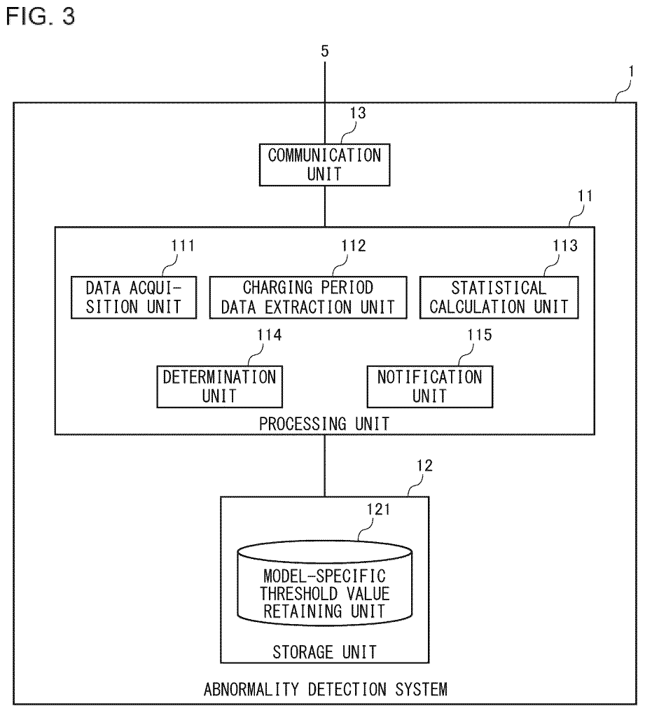

FIG. 3 is a diagram illustrating an exemplary configuration of the abnormality detection system according to the embodiment.

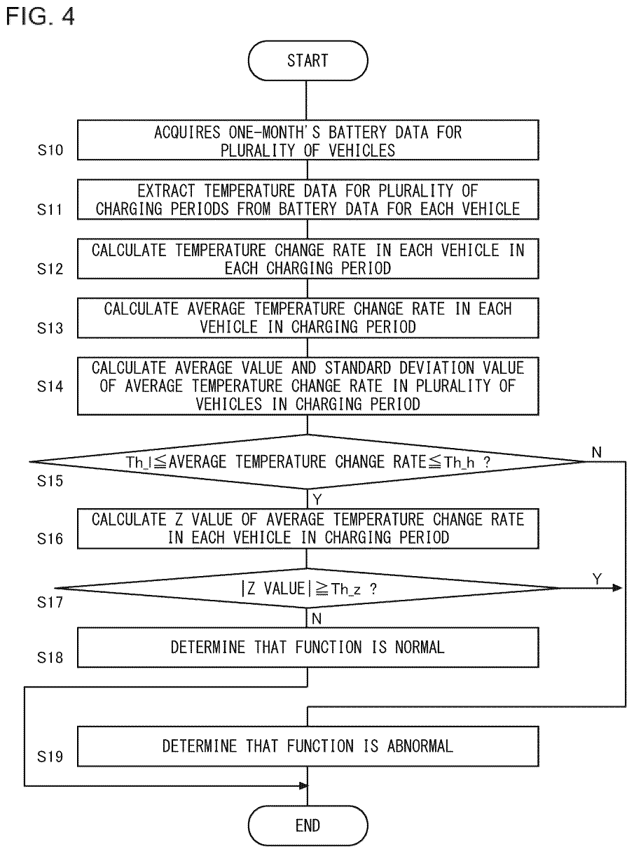

FIG. 4 is a flowchart showing the flow of a process of detecting an abnormality of the temperature adjustment function according to the embodiment.

### DETAILED DESCRIPTION OF THE INVENTION

The invention will now be described by reference to the preferred embodiments. This does not intend to limit the scope of the present invention, but to exemplify the invention.

FIG. 1 is a diagram showing a schematic configuration of an electric-powered vehicle 3 according to the embodiment. In this embodiment, a pure EV not equipped with an internal combustion engine is assumed as the electric-powered vehicle 3. The electric-powered vehicle 3 shown in FIG. 1 is a rear-wheel-drive (2WD) EV including a pair of front wheels 31f, a pair of rear wheels 31r, and a motor 34 as a power source. The pair of front wheels 31f are connected by a front wheel axle 32f, and the pair of rear wheels 31r are connected by a rear wheel axle 32r. A transmission 33 transmits the rotation of the motor 34 to the rear wheel axle 32r at a predetermined conversion ratio. The vehicle may be a front-wheel drive (2WD) or 4WD electric-powered vehicle 3.

A power supply system 40 includes a battery pack 41, a management unit 42, a cooler 43, and a heater 44. The battery pack 41 includes a plurality of cells. A lithium ion battery cell, a nickel hydride battery cell, or the like can be used as the cell. Hereinafter, an example of using a lithium ion battery cell (nominal voltage: 3.6-3.7 V) is assumed in this specification.

The cooler 43 is a water-cooled or air-cooled cooling mechanism for cooling the cells in the battery pack 41. A high temperature state of a cell accelerates deterioration of the cell and leads to the occurrence of an unsafe event. The cooler 43 operates to cool the cell when, for example, the battery pack 41 is charged or discharged. Further, the cooler 43 operates to cool the cell when the temperature of the battery pack 41 exceeds a preset value (for example, 35° C.-40° C.).

The heater 44 is a heating mechanism for heating the battery pack 41. When a lithium-ion battery is charged at a low temperature, dendritic crystals precipitate on the electrodes, which could cause deterioration or malfunction. For example, the heater 44 operates to heat the cell in the event that the temperature of the battery pack 41 falls below a preset value for charging (for example, 0° C.-10° C.) when the battery pack 41 is charged. Further, the heater 44 operates to heat the cell in the event that the temperature of the battery pack 41 falls below a preset value for discharging (for example, −15.0° C.-−5.0° C.) when the battery pack 41 is discharged.

The management unit 42 monitors and measures the voltage, current, temperature, and SOC (State Of Charge) of the plurality of cells included in the battery pack 41 and transmits them to a vehicle control unit 30 as usage data for the plurality of cells via the vehicle-mounted network. For example, CAN (Controller Area Network) or LIN (Local Interconnect Network) can be used as the vehicle-mounted network.

In EVs, a three-phase AC motor is generally used as the motor 34 for driving. An inverter 35 converts a DC power supplied from the battery pack 41 into an AC power and supplies it to the motor 34 during power running. During regeneration, the inverter 35 converts the AC power supplied from the motor 34 into a DC power and supplies it to the battery pack 41. The motor 34 rotates according to the AC power supplied from the inverter 35 during power running. During regeneration, the motor 34 converts the rotational energy caused by deceleration into an AC power and supplies it to the inverter 35.

The vehicle control unit 30 is a vehicle ECU (Electronic Control Unit) that controls the entire electric-powered vehicle 3 and may be, for example, comprised of an integrated VCM (Vehicle Control Module).

A vehicle speed sensor 36 generates a pulse signal proportional to the rotational speed of the front wheel axle 32f or the rear wheel axle 32r and transmits the generated pulse signal to the vehicle control unit 30. The vehicle control unit 30 detects the speed of the electric-powered vehicle 3 based on the pulse signal received from the vehicle speed sensor 36.

A wireless communication unit 37 includes a modem for wirelessly connecting to a network 5 (see FIG. 2) via an antenna 37a, and performs wireless signal process. For example, mobile phone networks (cellular networks), wireless LANs, V2I (Vehicle-to-Infrastructure), V2V (Vehicle-to-Vehicle), ETC (Electronic Toll Collection System) DSRC (Dedicated Short Range Communications) can be used.

The vehicle control unit 30 can transmit traveling data from the wireless communication unit 37 to a data server 6 (see FIG. 2) in real time via the network 5 while the electric-powered vehicle 3 is traveling. The traveling data at least includes a vehicle ID, a vehicle speed of the electric-powered vehicle 3, and a voltage, current, temperature, and SOC of the plurality of cells included in the battery pack 41. The vehicle control unit 30 periodically (for example, every 10 seconds) samples these data items and transmits them to the data server 6 as they arise.

It should be noted that the vehicle control unit 30 may store the traveling data for the electric-powered vehicle 3 in an internal memory and transmit the traveling data stored in the memory collectively according to a predetermined timing schedule. For example, the vehicle control unit 30 may collectively transmit the traveling data stored in the memory to an operation management terminal apparatus 2 (see FIG. 2) provided at a site of a delivery company at the end of the day's business. The operation management terminal apparatus 2 transmits the traveling data for the plurality of electric-powered vehicles 3 to the data server 6 according to a predetermined timing schedule.

Alternatively, the vehicle control unit 30 may collectively transmit the traveling data stored in the memory to the charger via the charging cable when the battery is charged from the charger provided with a network communication function. The charger transmits the received traveling data to the data server 6. This example is useful for the electric-powered vehicle 3 not equipped with a wireless communication function.

FIG. 2 is a diagram for illustrating an abnormality detection system 1 according to the embodiment. The abnormality detection system 1 according to the embodiment is a system used by at least one delivery company. The abnormality detection system 1 may, for example, be built on an in-house server provided in an in-house facility of a service provider that provides a service of detecting a failure of the temperature adjustment equipment of the battery pack 41 mounted on the electric-powered vehicle 3 or provided in a data center. Alternatively, the abnormality detection system 1 may be built on a cloud server that is used based on a cloud service. Alternatively, the abnormality detection system 1 may be built on a plurality of servers distributed at a plurality of sites (data centers, in-house facilities). The plurality of servers may be any of a combination of a plurality of in-house servers, a combination of a plurality of cloud servers, or a combination of an in-house server and a cloud server.

The network 5 is a general term for communication channels such as the Internet, leased lines, and VPN (Virtual Private Network), and the communication medium and the protocol thereof do not matter. For example, a mobile phone network (cellular network), a wireless LAN, a wired LAN, an optical fiber network, an ADSL network, a CATV network, and the like can be used as the communication medium. For example, TCP (Transmission Control Protocol)/IP (Internet Protocol), UDP (User Datagram Protocol)/IP, Ethernet (registered trademark) and the like can be used as the communication protocol.

The delivery company owns a plurality of electric-powered vehicles 3 and a plurality of chargers 4 and uses the plurality of electric-powered vehicles 3 for delivery business. It should be noted that the electric-powered vehicle 3 can be charged from a charger other than the charger 4 provided at a delivery base. The delivery company owns delivery bases for parking the electric-powered vehicle 3. The operation management terminal apparatus 2 is provided in the delivery base. For example, the operation management terminal apparatus 2 is comprised of a PC. The operation management terminal apparatus 2 is used to manage a plurality of electric-powered vehicle 3 belonging to the delivery base.

The operation management terminal apparatus 2 can access the abnormality detection system 1 via the network 5. Prior to using the abnormality detection system 1, the operation manager of the delivery company registers the model numbers of the plurality of electric-powered vehicles 3 managed by the system, using the operation management terminal apparatus 2. The operation management terminal apparatus 2 acquires the vehicle ID of the registered electric-powered vehicle 3 from the abnormality detection system 1. The operation management terminal apparatus 2 can acquire a diagnostic result of the temperature adjustment function of the battery pack 41 mounted on each electric-powered vehicle 3 from the abnormality detection system 1.

In a state where the electric-powered vehicle 3 is parked at the delivery base, the vehicle control unit 30 and the operation management terminal apparatus 2 can exchange data via the network 5 (for example, wireless LAN), a CAN cable, or the like. The vehicle control unit 30 and the operation management terminal apparatus 2 may be configured to exchange data via the network 5 even while the electric-powered vehicle 3 is traveling. The operation management terminal apparatus 2 sets the vehicle ID acquired from the abnormality detection system 1 in the vehicle control unit 30 of each electric-powered vehicle 3.

The data server 6 acquires and stores traveling data from the operation management terminal apparatus 2 or the electric-powered vehicle 3. The data server 6 may be an in-house server provided in the delivery company or the failure detection service provider's own facility or in a data center, or a cloud server used by the delivery company or the failure detection service provider. Further, each delivery company and failure detection service provider may have a data server 6.

FIG. 3 is a diagram illustrating an exemplary configuration of the abnormality detection system 1 according to the embodiment. The abnormality detection system 1 includes a processing unit 11, a storage unit 12, and a communication unit 13. The communication unit 13 is a communication interface (for example, NIC: Network Interface Card) for connecting to the network 5 by wire or wirelessly.

The processing unit 11 includes a data acquisition unit 111, a charging period data extraction unit 112, a statistical calculation unit 113, a determination unit 114, and a notification unit 115. The function of the processing unit 11 can be realized by cooperation between hardware resources and software resources or by hardware resources alone. Hardware resources such as CPU, ROM, RAM, GPU (Graphics Processing Unit), ASIC (Application Specific Integrated Circuit), FPGA (Field Programmable Gate Array), and other LSIs can be used. Programs such as operating systems and applications can be used as software resources.

The storage unit 12 is inclusive of a non-volatile recording medium such as a HDD and an SSD and stores various data. The storage unit 12 includes a model-specific threshold retaining unit 121. For each model of the electric-powered vehicle 3, the model-specific threshold retaining unit 121 retains the lower limit threshold value and the upper limit threshold value of the temperature change rate [° C./h] during charging described later. Since the specification of the temperature adjustment equipment mounted on the electric-powered vehicle 3 differs depending on the model of the electric-powered vehicle 3, there is also a difference in temperature change rate during charging. During charging, the temperature basically rises due to the influence of the charging current absent supercooling by the cooler 43.

For each model of the electric-powered vehicle 3, the failure detection service provider determines a range of temperature change rate during charging in a state where the temperature adjustment function is operating normally, based on actual data or simulation data. The fault detection service provider determines the lower limit threshold and the upper limit threshold value of the temperature change rate during charging by adding a predetermined margin to the range of temperature change rate during charging thus determined.

In the case the vehicle manufacturer publishes the specification of the temperature adjustment equipment, the failure detection service provider may identify the tolerable range of temperature change rate during charging based on the specification and determine the lower limit threshold value and the upper limit threshold value of the temperature change rate during charging.

The data acquisition unit 111 acquires, from the data server 6, battery data for the plurality of battery packs 41 mounted on the plurality of electric-powered vehicles 3 in a predetermined period (for example, one month). The battery data in the predetermined period is time series data including at least temperature data and current data. In the case a plurality of temperature sensors are provided in the battery pack 41, the maximum measured temperature, the minimum measured temperature, the average temperature between the maximum measured temperature and the minimum measured temperature in the battery pack 41, or the average temperature of a plurality of observation points are, for example, used as the temperature data in the battery pack 41.

The data acquisition unit 111 acquires, from the data server 6, battery data for the electric-powered vehicle 3 for which the temperature adjustment function is diagnosed and battery data for a plurality of electric-powered vehicles 3 of the same model as the diagnosed electric-powered vehicle 3. That is, the data acquisition unit 111 acquires battery data for at least three electric-powered vehicles 3 of the same model.

The charging period data extraction unit 112 extracts temperature data in a period, within the predetermined period, during which the duration that the charging current is flowing falls within a preset time range, as temperature data in the charging period. Whether the charging current is flowing can be determined based on the sign and absolute value of current data. The charging period data extraction unit 112 defines, for example, the preset time range of 50 minutes to 24 hours and extracts temperature data within the range as the temperature data in the charging period. In this example, a data pattern in which charging continues for 24 hours or longer is defined as indicating a data abnormality and is not handled as a charging period.

Further, when the number of temperature data items extracted in each charging period is less than the minimum number of data items, the charging period data extraction unit 112 does not handle the charging period as a charging period. Given that the battery data is sampled at 10 second intervals, and the minimum duration of the charging period is set to 50 minutes as described above, the minimum number of data items in a charging period is set to (300-α). α denotes a margin. Given that the predetermined period is one month and the electric-powered vehicle 3 is charged once a day, the number of charging periods extracted from the predetermined period will be approximately 30.

The statistical calculation unit 113 calculates, for each battery pack 41 of the electric-powered vehicle 3, a statistical value based on the temperature change rate in a plurality of charging periods included in the predetermined period. The temperature change rate in each charging period can be determined by dividing the temperature change value of each charging period, which is based on the temperature data at the beginning and end of each charging period, by the duration of the charging period. An average, a median, or a mode can be used as the statistical value based on the temperature change rate in the plurality of charging periods. In this embodiment, an example using an average value is assumed.

For each battery pack 41 of the electric-powered vehicle 3, the statistical calculation unit 113 averages the temperature change rates in the plurality of charging periods included in the predetermined period to calculate an average temperature change rate in the plurality of battery packs 41 in each charging period (hereinafter appropriately referred to as unit average temperature change rate). The statistical calculation unit 113 calculates an average value (hereinafter appropriately referred to as overall average temperature change rate) and a standard deviation value of the unit average temperature change rate in the plurality of battery packs 41 in each charging period.

The statistical calculation unit 113 calculates a Z value of the unit average temperature change rate in each battery pack 41 based on the overall average temperature change rate, the unit average temperature change rate in each battery pack 41, and the standard deviation value of a plurality of unit average temperature change rates (see expression (1) below). The Z value is a value obtained by standardizing the unit average temperature change rate by defining the average value of the unit average temperature change rate to be 0 and the standard deviation value to be 1.

Z=(overall average temperature change rate−unit average temperature change rate)/standard deviation value (expression 1).

It should be noted that a statistical value other than Z value may be used as long as it is a statistical value that can quantitatively evaluate a deviation of the unit average temperature change rate in the diagnosed battery pack 41 from the overall average temperature change rate. When the models of a plurality of electric-powered vehicles 3 are the same and the environments of usage are similar, for example, the deviation between the overall average temperature change rate and the unit average temperature change rate may be used directly.

The determination unit 114 determines the temperature adjustment function of the electric-powered vehicle 3 for which the deviation of the statistical value of the temperature change rate is equal to or greater than a standard deviation threshold value to be abnormal. Abnormalities of the temperature adjustment function include failure of the temperature adjustment equipment itself and failure of the temperature measurement system (for example, failure of a thermistor). In this embodiment, the determination unit 114 compares the standard deviation threshold value with the |Z value| of the unit average temperature change rate in each battery pack 41 and determines the temperature adjustment function of the electric-powered vehicle 3 for which the |Z value| of the unit average temperature change rate is equal to or greater than the standard deviation threshold value to be abnormal.

The failure detection service provider obtains the upper limit of the Z value of the unit average temperature change rate in a state where the temperature adjustment function of the electric-powered vehicle 3 is operating normally, based on actual data or simulation data. The failure detection service provider determines the standard deviation threshold value by adding a predetermined margin to the upper limit of the Z value of the unit average temperature change rate thus determined. For example, the standard deviation threshold value is generally set in a range of 2.0-4.0. If it is desired to detect signs of failure of the temperature adjustment function, the standard deviation threshold value may be set to be low. A common standard deviation threshold value may be preset for the entire electric-powered vehicles 3, or the standard deviation threshold value may be preset for each model of the electric-powered vehicle 3.

The determination unit 114 may compare the Z value of the unit average temperature change rate in each battery pack 41 with positive and negative standard deviation threshold values to diagnose an abnormality of the temperature adjustment function in more detail. When the Z value is equal to or greater than the positive standard deviation value, for example, the determination unit 114 assumes supercooling by the cooler 43 or insufficient heating by the heater 44. When the Z value is equal to or less than the negative standard deviation value, conversely, the determination unit 114 assumes insufficient cooling by the cooler 43 or overheating by the heater 44.

Further, when the average temperature change rate in the diagnosed battery pack 41 in the charging period is equal to or less than the lower limit threshold value or equal to or greater than the upper limit threshold value of the temperature change rate preset for each model, the determination unit 114 determines the temperature adjustment function of the electric-powered vehicle 3 equipped with the battery pack 41 to be abnormal. For example, the lower limit threshold value of the temperature change rate is set to 0. In the case the temperature change rate during charging becomes negative (the temperature decreases), it can be estimated that an abnormality has occurred in the temperature adjustment function. For example, the upper limit threshold value of the temperature change rate is set in a range of 10-20 [° C./h].

The notification unit 115 notifies the operation management terminal apparatus 2 of a result of diagnosis of the temperature adjustment function of the designated electric-powered vehicle 3 via the network 5. Regarding the electric-powered vehicle 3 for which the temperature adjustment function is determined to be abnormal by the determination unit 114, the notification unit 115 adds a message recommending that the temperature adjustment function be inspected. The delivery company repairs or replaces the battery when an abnormality is confirmed as a result of the inspection of the temperature adjustment function diagnosed as being abnormal.

FIG. 4 is a flowchart showing the flow of a process of detecting an abnormality of the temperature adjustment function according to the embodiment. The data acquisition unit 111 acquires one-month's battery data for a plurality of battery packs 41 mounted on a plurality of electric-powered vehicles 3 from the data server 6 (S10). The charging period data extraction unit 112 extracts temperature data in a plurality of charging periods from the battery data for each electric-powered vehicle 3 (S11).

The statistical calculation unit 113 calculates a temperature change rate in each electric-powered vehicle 3 in each charging period (S12). The statistical calculation unit 113 calculates the average temperature change rate in each electric-powered vehicle 3 in the charging period (S13). The statistical calculation unit 113 calculates an average value and a standard deviation value of the average temperature change rate in the plurality of electric-powered vehicles 3 in the charging period (S14).

The determination unit 114 determines whether the average temperature change rate in each electric-powered vehicle 3 in the charging period falls within a threshold value range between the lower limit threshold value Th_l and the upper limit threshold value Th_h (S15). The determination unit 114 determines the temperature adjustment function of the electric-powered vehicle 3 for which the average temperature change rate in the charging period does not fall within the threshold value range to be abnormal (S19).

The statistical calculation unit 113 calculates the Z value of the average temperature change rate in the charging period in all of the plurality of electric-powered vehicles 3 or in the electric-powered vehicle 3 for which the average temperature change rate in the charging period falls within the threshold value range (S16). The determination unit 114 compares the standard deviation threshold value Th_z with the |Z value| of the average temperature change rate in each electric-powered vehicle 3 in the charging period for which the average temperature change rate in the charging period falls within the threshold value range (S17). The determination unit 114 determines the temperature adjustment function of the electric-powered vehicle 3 for which the |z value| of the average temperature change rate in the charging period is less than the standard deviation threshold value Th_z to be normal (S18), and determines the temperature adjustment function of the electric-powered vehicle 3 for which the |Z value| is equal to or greater than the standard deviation threshold value Th_z to be abnormal (S19).

As described above, it is possible, according to this embodiment to diagnose the temperature adjustment function of the battery pack 41 at low cost while suppressing the influence of environmental temperature. In this embodiment, the temperature data in the charging period during which the temperature adjustment function is in effect is used so that the temperature adjustment function can be diagnosed with high accuracy. By comparing the temperature change rate in a plurality of electric-powered vehicles 3 in the charging period, the influence of environmental temperature can be eliminated. By detecting anomalous temperature data from the temperature data for a plurality of electric-powered vehicles 3, an abnormality of the temperature adjustment function can be determined. When comparing the data for the plurality of electric-powered vehicles 3, the diagnostic accuracy can be improved by comparing the temperature data for a plurality of electric-powered vehicles 3 of the same model or of similar environmental conditions (for example, charged by the same charger 4).

In this embodiment, there is no need for a sensor for separately measuring the environmental temperature, and a sensor for measuring the cell temperature in the battery pack 41 is sufficient, so that the cost can be suppressed. Further, by using the Z value of the average temperature change rate in the charging period, a determination can be made by using the same threshold value regardless of the model of the electric-powered vehicle 3. Further, by adjusting the value preset as the threshold value, it is possible to detect in advance signs of the occurrence of an abnormality of the temperature adjustment function.

Given above is a description of the present disclosure based on the embodiment. The embodiment is intended to be illustrative only and it will be understood by those skilled in the art that various modifications to combinations of constituting elements and processes are possible and that such modifications are also within the scope of the present disclosure.

In the above embodiment, the data acquisition unit 111 acquires battery data for a plurality of electric-powered vehicles 3 of the same model from the data server 6. When the number of samples is large, it is not necessary to limit the battery data to those of the electric-powered vehicles 3 of the same model. The data acquisition unit 111 may, for example, acquire battery data for a plurality of electric-powered vehicles 3 from the same vehicle manufacturer. Alternatively, battery data for a plurality of electric-powered vehicles 3 belonging to the same delivery company may be acquired.

In the above embodiment, a four-wheeled electric-powered vehicle is assumed as the electric-powered vehicle 3. The electric-powered vehicle 3 may be an electric motorcycle (electric scooter), an electric bicycle, or an electric kick scooter. Further, electric-powered vehicles include not only full-spec electric-powered vehicles but also low-speed electric-powered vehicles such as golf carts and land cars. Further, the target equipment on which the battery pack 41 is mounted is not limited to the electric-powered vehicle 3. The target equipment on which the battery pack 41 is mounted includes electric ships, railway vehicles, electric mobile objects such as multicopters (drones), stationary electricity storage systems, and consumer electronic equipment (PCs, tablets, smartphones, etc.).

The embodiment may be defined by the following items.

### [Item 1]

An abnormality detection system (1) including:
a data acquisition unit (111) that acquires temperature data for a plurality of battery packs (41) mounted on different equipment (3) in a predetermined period;
a statistical calculation unit (113) that calculates, for each battery pack (41), a statistical value based on a temperature change rate in a plurality of charging periods included in the predetermined period; and
a determination unit (114) that determines a temperature adjustment function of the equipment (3) for which a deviation of the statistical value based on the temperature change rate is equal to or greater than a threshold value to be abnormal.

Accordingly, it is possible to diagnose the temperature adjustment function of the battery pack (41) at low cost while suppressing the influence of environmental temperature.

### [Item 2]

The abnormality detection system (1) according to Item 1,
wherein the statistical calculation unit (113):
calculates, for each battery pack (41), an average, a median, or a mode of the temperature change rate in the plurality of charging periods included in the predetermined period and calculates a statistical temperature change rate in the plurality of battery packs (41) in a charging period respectively,
calculates an average value and a standard deviation value of the statistical temperature change rate in the plurality of battery packs (41) in a charging period,
calculates a Z value of the statistical temperature change rate of each battery pack (41) based on the average value and the standard deviation value of a plurality of statistical temperature change rates, and
determines whether the temperature adjustment function of each equipment (3) is abnormal by comparing the Z value with the threshold value.

Accordingly, a determination can be made with the same threshold value regardless of the model of the equipment (3), by using the Z value of the average temperature change rate in a charging period.

### [Item 3]

The abnormality detection system (1) according to Item 1 or 2,
wherein the data acquisition unit (111) acquires temperature data and current data for the plurality of battery packs (41) in a predetermined period,
wherein the abnormality detection system (1) further includes:
a charging period data extraction unit (112) that extracts temperature data in a period, in the predetermined period, during which a duration that a charging current is flowing falls within a preset time range, as temperature data in a charging period.

Accordingly, it is possible to diagnose the temperature adjustment function with high accuracy by using the temperature data in the charging period during which the temperature adjustment function is in effect.

### [Item 4]

The abnormality detection system (1) according to any one of Items 1 through 3,
wherein the equipment (3) is an electric-powered vehicle (3), and
wherein the plurality of battery packs (41) are battery packs (41) mounted on a plurality of electric-powered vehicles (3) of the same model.

Accordingly, the accuracy of diagnosis of the temperature adjustment function mounted on the electric-powered vehicle (3) can be improved.

### [Item 5]

The abnormality detection system (1) according to Item 2,
wherein the equipment (3) is an electric-powered vehicle (3),
wherein the plurality of battery packs (41) are battery packs (41) mounted on a plurality of electric-powered vehicles (3) of the same model, and
wherein, when a statistical temperature change rate in the battery pack (41) in a charging period is equal to or less than a lower limit threshold value or equal to or greater than an upper limit threshold value of a temperature change rate preset for each model, the determination unit (114) determines the temperature adjustment function of the equipment (3) equipped with the battery pack (41) to be abnormal.

Accordingly, the accuracy of diagnosis of the temperature adjustment function mounted on the electric-powered vehicle (3) can be further improved.

### [Item 6]

An abnormality detection method including:
acquiring temperature data for a plurality of battery packs (41) mounted on different equipment (3) in a predetermined period;
calculating, for each battery pack (41), a statistical value based on a temperature change rate in a plurality of charging periods included in the predetermined period; and
determining a temperature adjustment function of the equipment (3) for which a deviation of the statistical value based on the temperature change rate is equal to or greater than a threshold value to be abnormal.

Accordingly, it is possible to diagnose the temperature adjustment function of the battery pack (41) at low cost while suppressing the influence of environmental temperature.

### [Item 7]

An abnormality detection program including computer-implemented modules including:
a module that acquires temperature data for a plurality of battery packs (41) mounted on different equipment (3) in a predetermined period;
a module that calculates, for each battery pack (41), a statistical value based on a temperature change rate in a plurality of charging periods included in the predetermined period; and
a module that determines a temperature adjustment function of the equipment (3) for which a deviation of the statistical value based on the temperature change rate is equal to or greater than a threshold value to be abnormal.

Accordingly, it is possible to diagnose the temperature adjustment function of the battery pack (41) at low cost while suppressing the influence of environmental temperature.

1. An abnormality detection system comprising:
a data acquisition unit that acquires temperature data for a plurality of battery packs mounted on different equipment in a predetermined period;
a statistical calculation unit that calculates, for each battery pack (41), a statistical value based on a temperature change rate in a plurality of charging periods included in the predetermined period; and
a determination unit that determines a temperature adjustment function of the equipment for which a deviation of the statistical value based on the temperature change rate is equal to or greater than a threshold value to be abnormal.

2. The abnormality detection system according to claim 1,
wherein the statistical calculation unit:
calculates, for each battery pack, an average, a median, or a mode of the temperature change rate in the plurality of charging periods included in the predetermined period and calculates a statistical temperature change rate in the plurality of battery packs in a charging period respectively,
calculates an average value and a standard deviation value of the statistical temperature change rate in the plurality of battery packs in a charging period,
calculates a Z value of the statistical temperature change rate of each battery pack based on the average value and the standard deviation value of a plurality of statistical temperature change rates, and
determines whether the temperature adjustment function of each equipment is abnormal by comparing the Z value with the threshold value.

3. The abnormality detection system according to claim 1,
wherein the data acquisition unit acquires temperature data and current data for the plurality of battery packs in a predetermined period,
wherein the abnormality detection system further includes:
a charging period data extraction unit that extracts temperature data in a period, in the predetermined period, during which a duration that a charging current is flowing falls within a preset time range, as temperature data in a charging period.

4. The abnormality detection system according to claim 1,
wherein the equipment is an electric-powered vehicle, and
wherein the plurality of battery packs are battery packs mounted on a plurality of electric-powered vehicles of the same model.

5. The abnormality detection system according to claim 2,
wherein the equipment is an electric-powered vehicle,
wherein the plurality of battery packs are battery packs mounted on a plurality of electric-powered vehicles of the same model, and
wherein, when a statistical temperature change rate in the battery pack in a charging period is equal to or less than a lower limit threshold value or equal to or greater than an upper limit threshold value of a temperature change rate preset for each model, the determination unit determines the temperature adjustment function of the equipment equipped with the battery pack to be abnormal.

6. An abnormality detection method comprising:
acquiring temperature data for a plurality of battery packs mounted on different equipment in a predetermined period;
calculating, for each battery pack, a statistical value based on a temperature change rate in a plurality of charging periods included in the predetermined period; and
determining a temperature adjustment function of the equipment for which a deviation of the statistical value based on the temperature change rate is equal to or greater than a threshold value to be abnormal.

7. A non-transitory computer-readable recording medium having embodied thereon an abnormality detection program including computer-implemented modules including:
a module that acquires temperature data for a plurality of battery packs mounted on different equipment in a predetermined period;
a module that calculates, for each battery pack, a statistical value based on a temperature change rate in a plurality of charging periods included in the predetermined period; and
a module that determines a temperature adjustment function of the equipment for which a deviation of the statistical value based on the temperature change rate is equal to or greater than a threshold value to be abnormal.
